(19) United States
(12) Patent Application Publication
(10) Pub. No.: US 2026/0063856 A1
(43) Pub. Date: Mar. 5, 2026

(54) OPTICAL MODULE

(71) Applicant: SHINKO ELECTRIC INDUSTRIES CO., LTD., Nagano-shi (JP)

(72) Inventor: Masaki MATSUMOTO, Nagano-shi (JP)

(21) Appl. No.: 19/304,245

(22) Filed: Aug. 19, 2025

(30) Foreign Application Priority Data
Aug. 28, 2024 (JP) 2024-146391

(51) Int. Cl. G02B 6/42

(52) U.S. Cl. CPC G02B 6/4215; G02B 6/428

(57) ABSTRACT

An optical module includes a first optical component having a single first core, a second optical component having multiple second cores optically coupled to the first core by adiabatic coupling, and a separator separating the first core from the second cores in a first direction. The first core and the second cores are arranged to allow optical coupling from the first core to the second cores. The second cores are arranged side by side in a second direction that is orthogonal to the first direction. The first core overlaps the second cores in an overlapping region in a third direction that is orthogonal to both the first direction and the second direction. A first separation distance between two adjacent ones of the second cores in the second direction is greater than or equal to a second separation distance between the first core and the second cores in the first direction.

### CROSS-REFERENCE TO RELATED APPLICATIONS

This application is based upon and claims the benefit of priority from Japanese Patent Application No. 2024-146391, filed on Aug. 28, 2024, the entire contents of which are incorporated herein by reference.

### BACKGROUND

### 1. Field

The present disclosure relates to an optical module.

### 2. Description of Related Art

A typical optical module used for optical communication includes a wiring substrate, a first optical component, such as an optical waveguide stacked on the wiring substrate, and a second optical component optically connected to the first optical component. JP2021-018409A discloses an example of such an optical module.

### SUMMARY

In the above optical module, there is a demand for improvement in the connection reliability between the first optical component and the second optical component.

In one general aspect, an optical module includes a first optical component, a second optical component, and a separator. The first optical component includes a single first core. The second optical component includes multiple second cores optically coupled to the single first core by adiabatic coupling. The separator separates the single first core from the multiple second cores in a first direction. The first optical component is a separate component from the second optical component. The single first core and the multiple single second cores are arranged to allow optical coupling from the single first core to the multiple second cores. The multiple second cores are arranged side by side in a second direction that is orthogonal to the first direction. The single first core overlaps the multiple second cores in an overlapping region in a third direction that is orthogonal to both the first direction and the second direction. A first separation distance between two adjacent ones of the multiple second cores in the second direction is greater than or equal to a second separation distance between the single first core and the multiple second cores in the first direction.

Other features and aspects will be apparent from the following detailed description, the drawings, and the claims.

### BRIEF DESCRIPTION OF THE DRAWINGS

FIG. 1 is a schematic cross-sectional view of an optical module in accordance with an embodiment.

FIG. 2 is a schematic perspective view of the optical module illustrated in FIG. 1.

FIG. 3 is a schematic plan view of the optical module illustrated in FIG. 1.

FIG. 4 is a schematic cross-sectional view of a portion of the optical module illustrated in FIG. 1.

FIG. 5A is a schematic plan view of the optical module illustrated in FIG. 1.

FIGS. 5B, 5C, 5D, 5E, 5F, and 5G illustrate light intensity distribution at locations “b”, “c”, “d”, “e”, “f”, and “g”of FIG. 5A.

FIG. 6A is a schematic plan view of the optical module illustrated in FIG. 1 when optical components are misaligned.

FIGS. 6B, 6C, 6D, 6E, 6F, and 6G illustrate light intensity distribution at locations “b”, “c”, “d”, “e”, “f”, and “g”of FIG. 6A.

FIG. 7 is a graph illustrating the relationship of misalignment and coupling loss.

FIG. 8 is a schematic cross-sectional view of an optical module of a modified example.

FIG. 9 is a schematic cross-sectional view of an optical module of another modified example.

FIG. 10 is a schematic plan view illustrating an application example of the optical module in accordance with the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An embodiment of the present disclosure will now be described with reference to the accompanying drawings.

The accompanying drawings may not be drawn to scale, and the relative size, proportions, and depiction of elements may be exaggerated for clarity, illustration, or convenience. To facilitate understanding, hatching lines may not be illustrated or may be replaced by shadings in cross-sectional views. In the drawings, the X-axis, the Y-axis, and Z-axis are orthogonal to one another. In the description hereafter, to facilitate understanding, a direction extending along the X-axis will be referred to as the X-axis direction, a direction extending along the Y-axis will be referred to as the Y-axis direction, and a direction extending along the Z-axis will be referred to as the Z-axis direction. In this specification, the term “plan view” refers to a view of a subject taken in the Z-axis direction, unless otherwise specified. In this specification, the term “planar shape” refers to a shape of a subject as viewed in the Z-axis direction, unless otherwise specified. In this specification, the terms “top-bottom direction” and “left-right direction” correspond to directions when the drawings are oriented to an appropriate position allowing reference numerals of the elements to be read correctly. In this specification, the term “face” is used to indicate that surfaces or members are located in front of each other. In this case, the surfaces or members do not have to be entirely in front of each other and may be partially in front of each other. The term “face” is also used in this specification to describe situations including a case in which two members are in contact with each other in addition to a case in which two members are separated from each other. In the description of the present disclosure, a numerical range of “X1 to X2,” which is specified by the lower limit value X1 and the upper limit value X2, refers to a range that is greater than or equal to X1 and less than or equal to X2, unless otherwise specified.

### Overall Structure of Optical Module 10

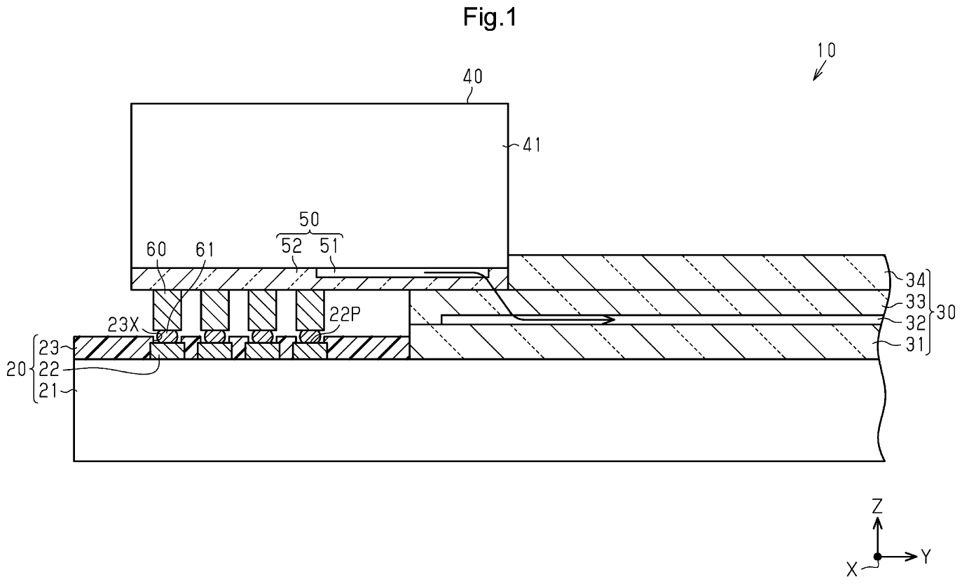

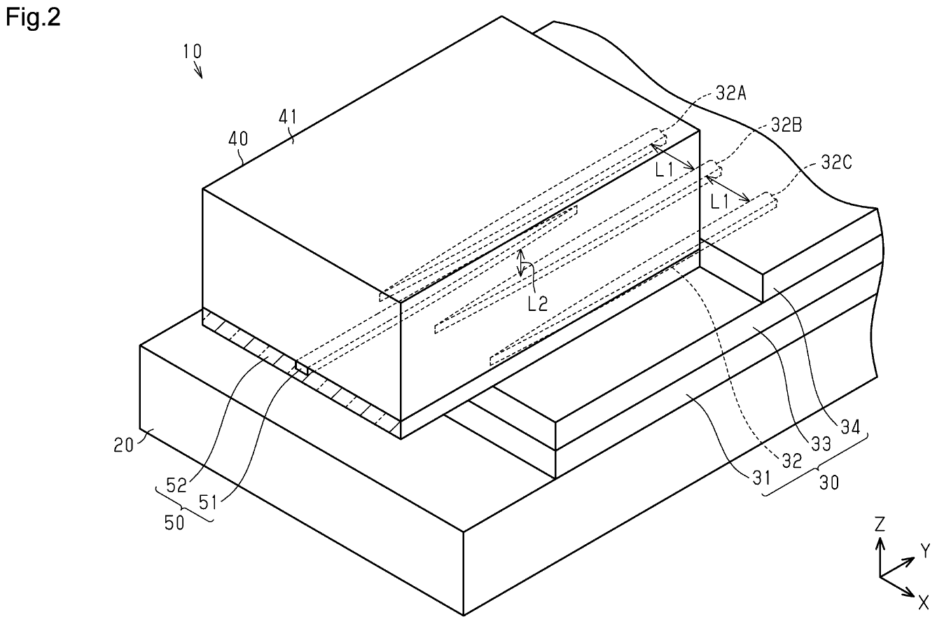

As illustrated in FIGS. 1 and 2, an optical module 10 includes a wiring substrate 20, an optical waveguide 30 formed on the wiring substrate 20, and an optical component 40 arranged on the wiring substrate 20.

### Structure of Wiring Substrate 20

As illustrated in FIG. 1, the wiring substrate 20 includes a substrate body 21, a wiring layer 22, and a solder resist layer 23. The substrate body 21 is, for example, plate-shaped. The substrate body 21 is, for example, rectangular in plan view.

The wiring layer 22 is arranged on the upper surface of the substrate body 21. The wiring layer 22 includes connection pads 22P electrically connected to the optical component 40. The material of the wiring layer 22 may be, for example, copper (Cu) or a copper alloy.

The solder resist layer 23 is formed on the upper surface of the substrate body 21 and covers the wiring layer 22. The solder resist layer 23 includes an opening 23X that exposes parts of the wiring layer 22 as the connection pads 22P.

A surface-processed layer may be formed on the wiring layer 22 exposed in the opening 23X. Examples of the surface-processed layer may include a gold (Au) layer, a nickel (Ni) layer/Au layer (metal layer in which the Ni layer serves as bottom layer, and the Au layer is stacked on the Ni layer), and a Ni layer/palladium (Pd) layer/Au layer (metal layer in which the Ni layer serves as bottom layer, and the Pd layer and the Au layer are sequentially stacked on the Ni layer). The Au layer is a metal layer of Au or a Au alloy. The Ni layer is a metal layer of Ni or a Ni alloy. The Pd layer is a metal layer of Pd or a Pd alloy. For example, the Au layer, the Ni layer, and the Pd layer may each be a metal layer formed by electroless plating (electroless plating metal layer). Alternatively, the surface-processed layer may be an organic solderability preservative (OSP) film formed by performing an oxidation-resisting process, such as an OSP process, on the surface of the external connection pads 22P. The OSP film may be, for example, an organic coating of an azole compound, an imidazole compound, or the like.

The optical component 40 serves as a first optical component, and is mounted on the wiring substrate 20. The optical waveguide 30 serves as a second optical component, and is arranged on the wiring substrate 20. The wiring substrate 20 may include a component other than the optical component 40 or the optical waveguide 30, such as an optical functional element or an electronic component. Examples of an optical functional element may include a light emitter, an optical modulator, an optical amplifier, an optical attenuator, and the like.

### Structure of Optical Waveguide 30

The optical waveguide 30 is, for example, formed on the upper surface of the substrate body 21 of the wiring substrate 20. The optical waveguide 30 includes, for example, a polymer optical waveguide. The optical waveguide 30 includes a cladding layer 31, cores 32, a cladding layer 33, and a cladding layer 34.

The cladding layer 31 is formed on the upper surface of the substrate body 21. The cladding layer 31 covers, for example, the upper surface of the substrate body 21 exposed from the solder resist layer 23. Multiple cores 32 are formed on the upper surface of the cladding layer 31.

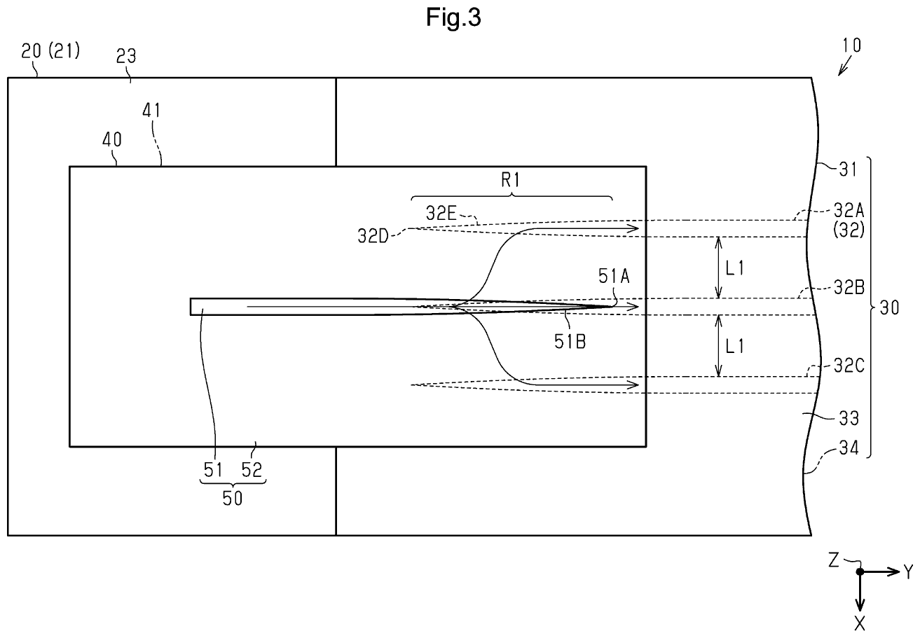

As illustrated in FIGS. 2 and 3, three cores 32 are formed on the upper surface of the cladding layer 31. The cores 32 are for propagation of optical signals. The cores 32 each have, for example, an elongated shape. The cores 32 extend, for example, in the Y-axis direction. The cores 32 each have, for example, a given width in the X-axis direction. In the present embodiment, the lengthwise direction (extension direction) of the cores 32 coincides the Y-axis direction, and the widthwise direction of the cores 32 coincides the X-axis direction. The cores 32 each have a shape of, for example, a quadrilateral post. As illustrated in FIG. 3, the three cores 32 are arranged side by side in the X-axis direction that is orthogonal to the lengthwise direction of the cores 32. The three cores 32 are spaced apart from one another by a first separation distance L1 in the X-axis direction. That is, two adjacent ones of the cores 32 are separated from each other by the first separation distance L1 in the X-axis direction. In other words, the first separation distance L1 represents a distance over which two adjacent ones of the three cores 32 are separated from each other in the X-axis direction. The three cores 32 extend, for example, parallel to one another.

To facilitate understanding, one of the three cores 32 located at an uppermost position in FIG. 3 may be referred to as “the core 32A”, one of the three cores 32 located at a middle position of the three cores 32 may be referred to as “the core 32B”, and one of the three cores 32 located at a lowermost position in FIG. 3 may be referred to as “the core 32C”. In the description hereafter, the cores 32A to 32C will be collectively referred to as “the cores 32”.

Each of the cores 32 includes an end 32D in the lengthwise direction of the core 32, and a tapered portion 32E decreased in diameter toward the end 32D. The end 32D corresponds to an end of the core 32 located at the left side in FIG. 3. The tapered portion 32E has a cross-sectional area that decreases toward the end 32D. The tapered portion 32E is narrowed toward the end 32D. FIG. 3 is a plan view of the optical module 10 illustrated in FIG. 1 taken from above as seen through the cladding layer 34 and the like. In FIG. 2, the solder resist layer 23 is omitted to simplify illustration.

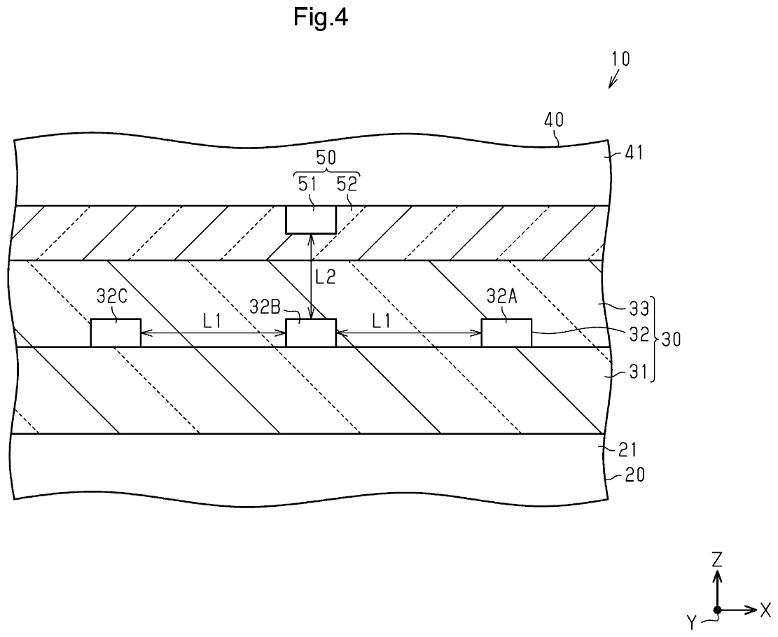

As illustrated in FIG. 4, the cladding layer 33 is formed on the upper surface of the cladding layer 31 to cover the cores 32. The cladding layer 33 fills gaps between adjacent cores 32. The cladding layer 33 covers the entire side surface of each core 32. The cladding layer 33 covers the entire upper surface of each core 32.

As illustrated in FIG. 1, the cladding layer 34 is formed on the upper surface of the cladding layer 33. The cladding layer 34 covers part of the upper surface of the cladding layer 33. The cladding layer 34 exposes a region of the upper surface of the cladding layer 33 located at the left side in FIG. 1.

As described above, the optical waveguide 30 includes a structure in which the cladding layer 31, the cores 32, the cladding layer 33, and the cladding layer 34 are stacked in this order on the upper surface of the substrate body 21. Furthermore, the optical waveguide 30 includes a structure in which each of the cores 32 is surrounded by the cladding layer 31 and the cladding layer 33.

Basically, the cladding layers 31, 33, 34 and the cores 32 may be formed from the same material. The material of the cladding layers 31, 33, and 34 and the cores 32 may be, for example, an epoxy-based resin, a silicone-based resin, or an acrylic resin, such as polymethyl methacrylate (PMMA). The material of the cores 32 is selected from a material having a higher refractive index than the material of the cladding layers 31 and 33 surrounding the cores 32, so that propagation of optical signals is limited to inside the cores 32. Although not particularly limited, it is preferred that a difference in the refractive index between each core 32 and the cladding layers 31, 33, and 34 be, for example, approximately 0.3% to 5.5%; and more preferably, approximately 0.8% to 2.2%.

In the drawings, the cladding layers 31, 33, and 34 are distinguished from one another by solid lines to facilitate understanding. In an actual optical module 10, the boundaries of the cladding layers 31, 33, and 34 may be absent or unclear.

As illustrated in FIG. 2, the optical waveguide 30 includes multiple waveguides defined by the cores 32. Each of the waveguides defined by the cores 32 has an independent propagation mode. In other words, the waveguides defined by the cores 32 have independent propagation modes. The waveguides defined by the cores 32 have the same propagation constant in a fundamental mode. For the sake of brevity, “the waveguides defined by the cores 32”may be simply referred to as “the cores 32”.

The cores 32 are, for example, optically connected (optically coupled) to one another. The cores 32 are optically coupled to one another, for example, by a supermode.

The cladding layer 31 may have a thickness of, for example, approximately 2 μm to 50 μm. The dimensions of the core 32 and the first separation distance L1 are each set so that each of the three cores 32 has an independent propagation mode. The cores 32 may each have a thickness of, for example, approximately 0.2 μm to 10 μm. The cores 32 may each have a width of, for example, approximately 0.2 μm to 10 μm. In the optical waveguide 30 of the present embodiment, the three cores 32A, 32B, and 32C are set to have the same dimensions (thickness and width), so that the three cores 32 have the same propagation constant in the fundamental mode.

The first separation distance L1 between two adjacent cores 32 may be, for example, approximately 0.5 μm to 10 μm. The first separation distance L1 between the core 32A and the core 32B may be the same as, or differ from, the first separation distance L1 between the core 32B and the core 32C. That is, the intervals of the cores 32 may be fixed or irregular.

The cladding layer 33 may have a thickness of, for example, approximately 0.2 μm to 5 μm. The cladding layer 34 may have a thickness of, for example, approximately 2 μm to 50 μm.

### Structure of Optical Component 40

The optical component 40 is a separate component from the optical waveguide 30. The optical component 40 includes, for example, a photonic integrated circuit (PIC) element. The PIC element includes, for example, an optical circuit. The optical circuit includes, for example, an optical element, an optical modulation circuit, or the like.

As illustrated in FIG. 1, the optical component 40 includes, for example, a main body 41, an optical waveguide 50, and connection terminals 60. The main body 41 is, for example, box-shaped. The optical waveguide 50 projects downward from the lower surface of the main body 41. The optical waveguide 50 is optically connected to the optical waveguide 30. The optical waveguide 50 is optically coupled to the optical waveguide 30 by an adiabatic coupling. The optical waveguide 50 may include, for example, a silicon optical waveguide or a spot size converter.

The optical waveguide 50 includes a single core 51 and a cladding layer 52. The core 51 is formed on, for example, the lower surface of the main body 41. The core 51 is for propagation of optical signals. The cladding layer 52 is formed on the lower surface of the main body 41 to cover the core 51. The cladding layer 52 covers the entire side surface of the core 51. The cladding layer 52 covers the entire lower surface of the core 51. The material of the cladding layer 52 may be, for example, silicon oxide (SiO₂) or the like. The material of the core 51 is selected from a material having a higher refractive index than the cladding layer 52 formed of SiO₂, so that propagation of optical signals is limited to inside the core 51. The material of the core 51 may be, for example, silicon (Si).

The optical waveguide 50 is a single waveguide including the single core 51. In the description hereafter, “the waveguide defined by the core 51” may be simply referred to as “the core 51”.

The core 51 may have, for example, a propagation constant that is the same as or differs from that of each core 32. Preferably, the core 51 has, for example, a greater propagation constant than each core 32. Preferably, the core 51 has, for example, a propagation constant that is equal to the propagation constant in a state in which the three cores 32 are optically coupled to one another.

As illustrated in FIG. 3, the optical module 10 of the present embodiment includes the three cores 32 with respect to the single core 51. The single core 51 is optically coupled to the three cores 32 by adiabatic coupling. The core 51 is arranged with respect to the cores 32 to allow optical coupling from the core 51 to the cores 32. In FIG. 3, the optical component 40 is seen through the main body 41.

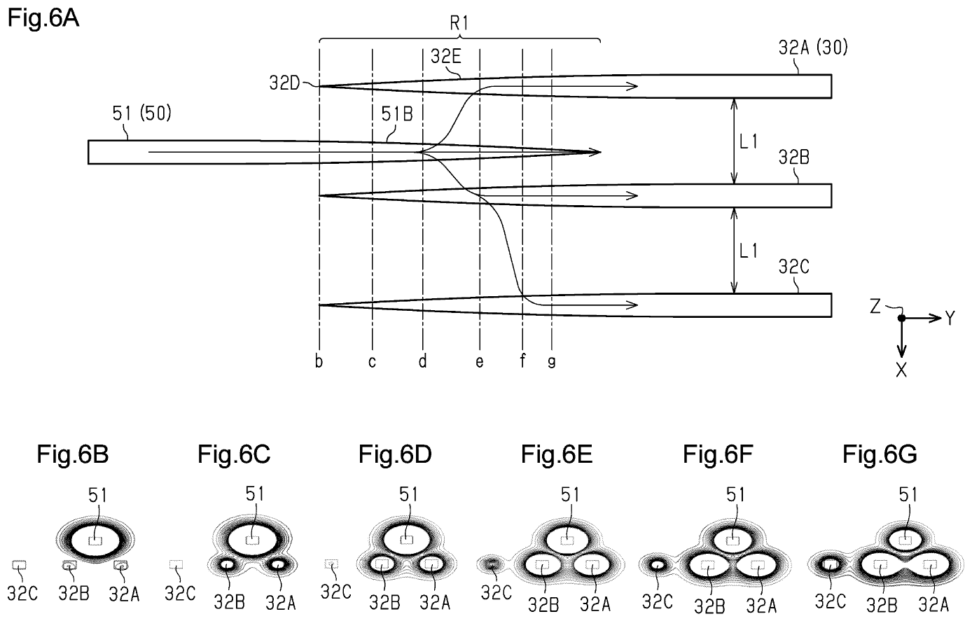

The core 51 has, for example, an elongated shape. The core 51 extends, for example, in the Y-axis direction. The core 51 has, for example, a given width in the X-axis direction. In particular, in the present embodiment, the lengthwise direction (extension direction) of the core 51 coincides the Y-axis direction, and the widthwise direction of the core 51 coincides the X-axis direction. The core 51 of the present embodiment is arranged so that, in plan view, part of the core 51 overlaps the core 32B located at the middle position of the three cores 32. Depending on the arrangement accuracy of the optical component 40 on the optical waveguide 30, the core 51 may be displaced in the X-axis direction. For example, as illustrated in FIG. 6, the core 51 may be located between two cores 32A and 32B in plan view.

As illustrated in FIG. 4, the core 51 of the present embodiment is arranged to face the core 32B. The core 51 is spaced apart from the cores 32 by a second separation distance L2 in the Z-axis direction. That is, the core 51 is separated from the cores 32 by the second separation distance L2 in the Z-axis direction. In other words, the second separation distance L2 represents a distance over which the core 51 is separated from the cores 32 in the Z-axis direction. In the present embodiment, the cladding layer 52 and the cladding layer 33 separate the core 51 from and the cores 32. That is, the cladding layer 52 and the cladding layer 33 act as a separator that separates the core 51 from the cores 32 in the Z-axis direction. The second separation distance L2 is set to be less than or equal to the first separation distance L1 between two adjacent cores 32. In other words, the first separation distance L1 is set to be greater than or equal to the second separation distance L2. The first separation distance L1 is set in such a manner described above, so that the interval of the three cores 32 may be relatively wide, and each of the three cores 32 may have an independent propagation mode. The second separation distance L2 may be readily adjusted by changing the distance from the lower surface of the core 51 to the lower surface of the cladding layer 52 and the distance from the upper surface of the core 32 to the upper surface of the cladding layer 33. The second separation distance L2 may be, for example, approximately 0.2 μm to 5 μm. The first separation distance L1 may be, for example, approximately 0.2 μm to 10 μm.

As illustrated in FIG. 3, the core 51 includes an end 51A in the lengthwise direction of the core 51, and a tapered portion 51B decreased in diameter toward the end 51A. The end 51A corresponds to an end of the core 51 located at the right side in the drawings. The tapered portion 51B has a cross-sectional area that decreases toward the end 51A. The tapered portion 51B is narrowed toward the end 51A.

The core 51 is arranged to overlap the cores 32 in the lengthwise direction of the core 51 (i.e., Y-axis direction). In particular, the optical module 10 includes an overlapping region R1 in which the single core 51 overlaps the multiple cores 32 in the lengthwise direction of the cores 32 and 51. In the overlapping region R1, for example, the tapered portion 51B of the core 51 overlaps the tapered portions 32E of the cores 32. That is, the tapered portion 51B and the tapered portions 32E are arranged in the overlapping region R1. Also, the end 51A of the core 51 and the ends 32D of the cores 32 are arranged in the overlapping region R1.

The core 51 may have a thickness of, for example, approximately 0.2 μm to 10 μm. The core 51 may have a width of, for example, approximately 0.5 μm to 10 μm. The cladding layer 52 may have a thickness of, for example, approximately 0.2 μm to 5 μm.

As illustrated in FIG. 1, the connection terminals 60 are, for example, arranged on the lower surface of the cladding layer 52. The connection terminals 60 project downward from the lower surface of the cladding layer 52. The connection terminals 60 are rod-shaped. The connection terminals 60 are, for example, electrically connected to an optical circuit (not illustrated) arranged on the main body 41.

The above-described optical component 40 is mounted on the wiring substrate 20, and is arranged on the optical waveguide 30. For example, the optical component 40 is flip-chip mounted on the upper surface of the wiring substrate 20, and is arranged on the upper surface of the cladding layer 33 exposed from the cladding layer 34. The connection terminals 60 of the optical component 40 are, for example, electrically connected to the connection pads 22P of the wiring substrate 20 via a solder layer 61. Accordingly, the optical component 40 is electrically connected to the connection pads 22P via the connection terminals 60 and the solder layer 61. Also, the optical component 40 is arranged on the optical waveguide 30, so that the cladding layer 52 is bonded to the upper surface of the cladding layer 33 exposed from the cladding layer 34. In the optical module 10 of the present embodiment, for example, the cladding layer 52 is arranged on the upper surface of the cladding layer 33 that is in an uncured state (rubber state), and then the cladding layer 33 is cured to bond the cladding layer 33 and the cladding layer 52.

Furthermore, for example, the optical component 40 is arranged on the upper surface of the cladding layer 33, such that the end surface of the optical component 40 in the Y-axis direction is forced against the end surface of the cladding layer 34 in the Y-axis direction. This allows the optical component 40 to be accurately positioned in the Y-axis direction when the end surface of the optical component 40 in the Y-axis direction is forced against the end surface of the cladding layer 34 in the Y-axis direction.

### Light Propagation

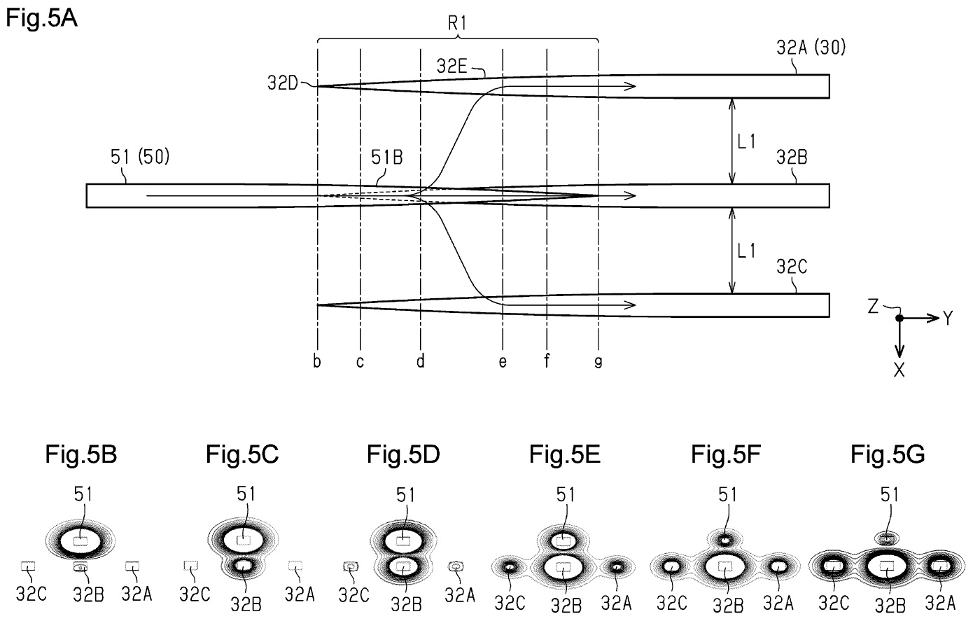

An example of light propagation in the optical module 10 will now be described with reference to FIGS. 5A to 5G. In this example, the optical component 40 is arranged such that, in plan view, the core 51 overlaps the core 32B located at the middle position of the three cores 32. FIGS. 5B to 5G illustrate contour lines representing calculated light intensity distribution (mode profile) of the optical waveguides 30 and 50 at locations “b” to “g” of FIG. 5A. FIGS. 5B to 5G illustrate the light intensity distribution in cross sections orthogonal to the lengthwise direction of the optical waveguides 30 and 50 (Y-axis direction). In the light intensity distribution illustrated in FIGS. 5B to 5G, light intensity is higher on the inner contour lines than on the outer contour lines.

As illustrated in FIG. 5A, the light input to the single core 51 is propagated from the single core 51 to the three cores 32 as a whole (refer to the arrows in FIG. 5A). Such propagation of light will be described in detail below.

The light input to the single core 51 is propagated through the core 51 as light of a single mode. This light is propagated through the core 51 in the lengthwise direction of the core 51 (in FIG. 5A, rightward direction). When the light enters the overlapping region R1 of the core 51 and the cores 32, the propagated light is transferred from the core 51 to the middle core 32B. As the width of the core 51 decreases along the tapering portion 51B of the core 51 in the light propagation direction, the light leaks out of the core 51 and increases the spot size. This widens the mode of the light in the tapered portion 51B of the core 51. In this case, the middle core 32B located below the core 51 via the cladding layers 52 and 33 (refer to FIG. 4) affects the light having an increased spot size, that is, the light of a widened mode, such that the light is adiabatically coupled to the core 32B (refer to FIGS. 5B to 5D). In other words, the light propagating through the core 51 is transferred to the core 32B in the overlapping region R1 in accordance with adiabatic coupling of the optical power from the core 51 to the middle core 32B. In this manner, the light propagating through the core 51 is adiabatically coupled to the middle core 32B over a given coupling length. As a result, the light is three-dimensionally propagated from the core 51 toward the middle core 32B, which is located below the core 51 via the cladding layers 52 and 33 (refer to FIG. 4).

As described above, each of the three cores 32 has an independent propagation mode. In particular, in the optical waveguide 30, the dimensions of the cores 32, the first separation distance L1 between two adjacent cores 32, and the like are set so that each of the three cores 32 has an independent propagation mode. The first separation distance L1 is set to be greater than or equal to the second separation distance L2 between the core 51 and the cores 32 in the Z-axis direction (refer to FIG. 4), so that the distance (L1) between two adjacent cores 32 is relatively large. This allows the optical waveguide 30 to include three independent waveguides defined by the three cores 32. Accordingly, the light propagating through the core 51 is not directly optically coupled from the core 51 to the three cores 32, but the light is first optically coupled to only the middle core 32B of the three cores 32 that is located immediately below the core 51. As a result of this optical coupling, the unimodal light intensity distribution at the location illustrated in FIG. 5B is converted to the bimodal light intensity distribution at the location illustrated in FIG. 5D. The bimodal light intensity distribution in FIG. 5D includes a peak of the light propagating through the core 51 and a peak of the light propagating through the middle core 32B.

Subsequently, as illustrated in FIG. 5A, the light that reached the middle core 32B is propagated through the core 32B in the lengthwise direction of the core 32B (in FIG. 5A, rightward direction). Then, the light is distributed from the middle core 32B to the two cores 32A and 32C located at the opposite sides of the core 32B. In this case, the cores 32A and 32C located at the opposite sides of the core 32B via the cladding layer 33 (refer to FIG. 4) affect the light propagating through the middle core 32B, such that the light is adiabatically coupled to the cores 32A and 32C (refer to FIGS. 5E to 5G). In other words, the light propagating through the middle core 32B is distributed to the cores 32A and 32C in accordance with adiabatic coupling of the optical power from the middle core 32B to the cores 32A and 32C, which are located at the opposite sides of the middle core 32B. In this manner, the light propagating through the middle core 32B is adiabatically coupled to the cores 32A and 32C over a given coupling length. The coupling length of adiabatic coupling between the core 32B and the two cores 32A and 32C is longer than the coupling length of adiabatic coupling between the core 51 and the core 32B. As described above, the core 32B and the cores 32A and 32C have the same propagation constant in the fundamental mode. In particular, the three cores 32A, 32B, 32C have the same dimensions and are formed from the same material, so that the three cores 32A, 32B, 32C have the same propagation constant in the fundamental mode. This allows for appropriate optical coupling of the light propagating through the middle core 32B to the cores 32A and 32C having the same propagation constant as the core 32B in the fundamental mode at the opposite sides of the core 32B. As a result of this optical coupling, the bimodal light intensity distribution at the location illustrated in FIG. 5D is converted to the trimodal light intensity distribution at the location illustrated in FIG. 5G. The trimodal light intensity distribution in FIG. 5G includes three peaks of the light propagating through the three cores 32.

In a case in which the core 51 is arranged to overlap the core 32B, the light input to the single core 51 is first propagated from the core 51 to the core 32B, and then distributed from the core 32B to the remaining cores 32A and 32C. In this manner, the optical waveguide 50 including the single core 51 is optically connected to the optical waveguide 30 including the three cores 32 by adiabatic coupling.

Another example of light propagation in the optical module 10 will now be described with reference to FIGS. 6A to 6G. In this example, the optical component 40 is arranged such that, in plan view, the core 51 is located between the two cores 32A and 32B. In other words, the optical component 40 is displaced from the desired position illustrated in FIG. 5A in the X-axis direction. FIGS. 6B to 6G illustrate contour lines representing calculated light intensity distribution (mode profile) of the optical waveguides 30 and 50 at locations “b” to “g” of FIG. 6A. FIGS. 6B to 6G illustrate the light intensity distribution in cross sections orthogonal to the lengthwise direction of the optical waveguides 30 and 50 (Y-axis direction).

As illustrated in FIG. 6A, the light input to the single core 51 is propagated from the single core 51 to the three cores 32 as a whole (refer to the arrows in FIG. 6A). Such propagation of light will be described in detail below.

The light input to the single core 51 is propagated through the core 51 as light of a single mode. This light is propagated through the core 51 in the lengthwise direction of the core 51 (in FIG. 6A, rightward direction). When the light enters the overlapping region R1 of the core 51 and the cores 32, the propagated light is transferred from the core 51 to the two cores 32A and 32B. As the width of the core 51 decreases along the tapering portion 51B of the core 51 in the light propagation direction, the light leaks out of the core 51 and increases the spot size. In this case, the cores 32A and 32B located near the core 51 via the cladding layers 52 and 33 (refer to FIG. 4) affect the light having an increased spot size, such that the light is adiabatically coupled to the cores 32A and 32B (refer to FIGS. 6B to 6D). In other words, the light propagating through the core 51 is transferred to the cores 32A and 32B in the overlapping region R1 in accordance with adiabatic coupling of the optical power from the core 51 to the two cores 32A and 32B. In this manner, the light propagating through the core 51 is adiabatically coupled to the two cores 32A and 32B, which are located at opposite sides of the core 51 in plan view, over a given coupling length. The light is coupled to the two cores 32A and 32B, instead of only the core 32B, such that the virtual propagation constant increases and the coupling length becomes longer.

As described above, the light is three-dimensionally propagated from the core 51 toward the two cores 32A and 32B, which are located below the core 51 via the cladding layers 52 and 33 (refer to FIG. 4). Accordingly, the light propagating through the core 51 is optically coupled from the core 51 to the two cores 32A and 32B located near the core 51. As a result of this optical coupling, the unimodal light intensity distribution at the location illustrated in FIG. 6B is converted to the trimodal light intensity distribution at the location illustrated in FIG. 6D. The bimodal light intensity distribution in FIG. 6D includes a peak of the light propagating through the core 51 and two peaks of the light propagating through the cores 32A and 32B.

Subsequently, as illustrated in FIG. 6A, the light that reached the cores 32A and 32B is propagated through the cores 32A and 32B in the lengthwise direction of the cores 32A and 32B (in FIG. 6A, rightward direction). Then, the light propagating through the middle core 32B is distributed from the core 32B to the core 32C (in FIG. 6A, located below the core 32B). In this case, the core 32C located next to the core 32B via the cladding layer 33 (refer to FIG. 4) affects the light propagating through the middle core 32B, such that the light is adiabatically coupled to the core 32C (refer to FIGS. 6E to 6G). In other words, the light propagating through the middle core 32B is distributed to the core 32C in accordance with adiabatic coupling of the optical power from the middle core 32B to the core 32C. In this manner, the light propagating through the core 32B is adiabatically coupled to the core 32C over a given coupling length. As described above, the core 32B and the core 32C have the same propagation constant in the fundamental mode. This allows for appropriate optical coupling of the light propagating through the core 32B to the core 32C having the same propagation constant as the core 32B in the fundamental mode. As a result of this optical coupling, the trimodal light intensity distribution at the location illustrated in FIG. 6D is converted to the tetramodal light intensity distribution at the location illustrated in FIG. 6G. The tetramodal light intensity distribution in FIG. 6G has a peak of the light propagating through the core 51 and three peaks of the light propagating through the three cores 32.

Even in a case in which the core 51 is displaced in the X-axis direction, the light input to the single core 51 is first propagated from the core 51 to the two cores 32A and 32B, and then distributed from the core 32B to the remaining core 32C. In this case, the coupling length of adiabatic coupling of the light propagated through the core 51 to the two cores 32A and 32B is relatively large. However, some of the light transferred to the two cores 32A and 32B is further transferred to the remaining core 32C, so that an increase in the coupling loss may be limited. Also, the coupling loss may be limited by adjusting the first separation distance L1 between two adjacent cores 32 and the second separation distance L2 between the cores 32 and the core 51 in the Z-axis direction to minimize variations in the equivalent refractive index in the X-axis direction. Furthermore, the coupling efficiency may be improved by setting the core 51 to have a greater propagation constant than each core 32 such that the propagation constant of the core 51 is relatively close to the propagation constant in a state in which the three cores 32 are coupled to one another. In these manners, even in a case in which the core 51 is displaced in the X-axis direction, an increase in the coupling loss may be limited effectively. This widens the tolerable displacement range of the core 51 relative to the three cores 32 in the X-axis direction when arranging the optical component 40 on the optical waveguide 30. In particular, the cores 32 having independent propagation modes are spaced apart from one another in the X-axis direction, so that the tolerable range of manufacturing accuracy of the core 51 in the X-axis direction may be widened. As a result, the manufacturing yield rate is improved while restricting the coupling loss (propagation loss).

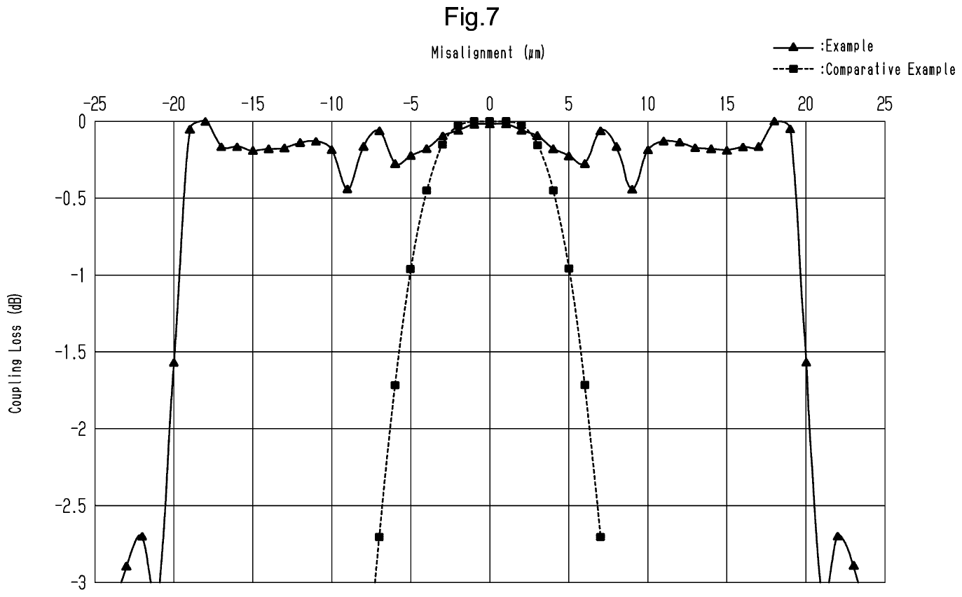

FIG. 7 is a graph illustrating the relationship of displacement amount (misalignment) of the core 51 in the X-axis direction and coupling loss. FIG. 7 indicates simulation results of the Example in which a single core 51 is adiabatically coupled to six cores 32 having independent propagation modes (refer to the solid line), and the Comparative Example in which a single core 51 is adiabatically coupled to a single core 32 (refer to the broken line). In the simulations of FIG. 7, the length of the overlapping region R1 of the cores 32 and the core 51 was set to 1.6 mm.

As illustrated in FIG. 7, in the Comparative Example in which a single core 51 is adiabatically coupled to a single core 32, the coupling loss increased as the degree of misalignment of the core 51 in the X-axis direction increased. For example, when a coupling loss of −1.0 dB is anticipated, the Comparative Example may tolerate only a misalignment of approximately ±5 μm. In contrast, in the Example in which six cores 32 having independent propagation modes are arranged side by side in the X-axis direction, the coupling loss was relatively even over a wider range of misalignment. Accordingly, when a coupling loss of −1.0 dB is anticipated, the Example may tolerate a misalignment of approximately ±20 μm. Such a tolerable range of misalignment may be widened by increasing the number of cores 32 arranged side by side in the X-axis direction. Theoretically, misalignment of the core 51 in the X-axis direction may be infinitely tolerated by increasing the number of the cores 32 arranged side by side in the X-axis direction.

### Advantages of the Present Embodiment

(1) The optical module 10 includes the optical component 40 and the optical waveguide 30. The optical component 40 includes the single core 51. The optical waveguide 30 includes the multiple cores 32 optically coupled to the single core 51 by adiabatic coupling. The optical module 10 includes the separator (here, cladding layers 33 and 52) that separates the single core 51 from the cores 32 in a first direction (Z-axis direction). The optical component 40 is a separate component from the optical waveguide 30 and is arranged on the optical waveguide 30. The single core 51 and the multiple cores 32 are arranged to allow optical coupling from the single core 51 to the multiple cores 32. The multiple cores 32 are arranged side by side in a second direction (X-axis direction) that is orthogonal to the first direction. The single core 51 overlaps the multiple cores 32 in the overlapping region R1 in a third direction (Y-axis direction) that is orthogonal to both the first direction and the second direction. The first separation distance L1 between two adjacent ones of the three cores 32 in the X-axis direction is greater than or equal to the second separation distance L2 between the single core 51 and the multiple cores 32 in the Z-axis direction.

With this structure, the cores 32, having independent propagation modes, are arranged side by side in the X-axis direction, and the single core 51 is adiabatically coupled to the cores 32. Therefore, even in a case in which the single core 51 is displaced in the X-axis direction, an increase in the coupling loss between the single core 51 and the multiple cores 32 may be limited effectively. This widens the tolerable displacement range of the core 51 relative to the multiple cores 32 in the X-axis direction when arranging the optical component 40 on the optical waveguide 30. As a result, even in a case in which the single core 51 is displaced in the X-axis direction, the single core 51 is optically coupled to the multiple cores 32 in a preferred manner, thereby improving the connection reliability between the single core 51 and the multiple cores 32.

(2) The cores 32 having independent propagation modes are spaced apart from one another in the X-axis direction, so that the tolerable range of manufacturing accuracy of the core 51 in the X-axis direction may be widened. For example, the number of cores 32, the first separation distance L1, and the like may be adjusted so that the tolerable range of manufacturing accuracy of the core 51 in the X-axis direction is wider than the tolerable range of mounting accuracy when the optical component 40 is flip-chip mounted on the wiring substrate 20. This contributes to implementation of passive alignment that simultaneously achieves flip-chip mounting of the optical component 40 on the wiring substrate 20 and optical coupling between the single core 51 and the multiple cores 32. Passive alignment differs from active alignment in that optical monitoring is unnecessary. Compared to active alignment, passive alignment obtains superior manufacturing efficiency by reducing the number of manufacturing processes and the time required for adjustment. Accordingly, implementation of passive alignment may improve the manufacturing efficiency of the optical module 10.

(3) In a case in which the single core 51 is adiabatically coupled to the multiple cores 32, the intervals of the cores 32 and the dimensions of the cores 32 may be set to allow for propagation of light through the multiple cores 32 in a single optical mode. However, such setting may impose significant structural limitations on the cores 32. Further, the first separation distance L1 between adjacent cores 32 needs to be extremely small. Thus, it is difficult to widen the tolerable range of manufacturing accuracy of the core 51 in the X-axis direction by a relatively large amount. In other words, it is difficult to expand the tolerable range of manufacturing accuracy of the core 51 in the X-axis direction to be wider than the mounting accuracy of flip-chip mounting of the optical component 40 on the wiring substrate 20

In contrast, in the optical module 10 of the present embodiment, the first separation distance L1 between two adjacent cores 32 in the X-axis direction is set to be greater than or equal to the second separation distance L2 between the single core 51 and the multiple cores 32 in the Z-axis direction, so that the cores 32 have independent propagation modes. In this case, the first separation distance L1 may be greater than when the cores 32 are formed to allow for propagation of light in a single optical mode, and the tolerable range of manufacturing accuracy of the core 51 in the X-axis direction may be widened in a preferred manner.

(4) The optical component 40 includes the cladding layer 52 that covers the single core 51. The optical waveguide 30 includes the cladding layer 33 that covers the multiple cores 32. The optical component 40 is arranged on the optical waveguide 30, so that the cladding layer 52 is bonded onto the cladding layer 33. The separator includes the cladding layer 52 and the cladding layer 33. With this structure, the cladding layers 33 and 52, serving as the separator, appropriately separate the single core 51 from the multiple cores 32 in the Z-axis direction.

(5) The tapered portion 51B of the single core 51 overlaps the tapered portions 32E of the cores 32 in the lengthwise direction of the cores 51 and 32. With this structure, the core 51 and the cores 32 have the same propagation constant at any position in the overlapping region R1 of the tapered portion 51B and the tapered portions 32E. This allows for appropriate optical coupling between the single core 51 and the multiple cores 32.

(6) The propagation constant of the single core 51 is set to be greater than the propagation constant of each of the multiple cores 32. With this structure, the propagation constant of the single core 51 is relatively close to the propagation constant in a state in which the three cores 32 are coupled to one another. This improves the coupling efficiency of the core 51 and the cores 32.

### Modified Examples

The above embodiment may be modified as described below. The above embodiment and the following modifications may be combined as long as there is no technical contradiction.

In the above embodiment, the separator that separates the cores 32 from the core 51 in the Z-axis direction includes the cladding layer 33 and the cladding layer 52. That is, the separator of the above embodiment has a two-layer structure including the cladding layer 33 and the cladding layer 52. However, the separator does not have to have a two-layer structure.

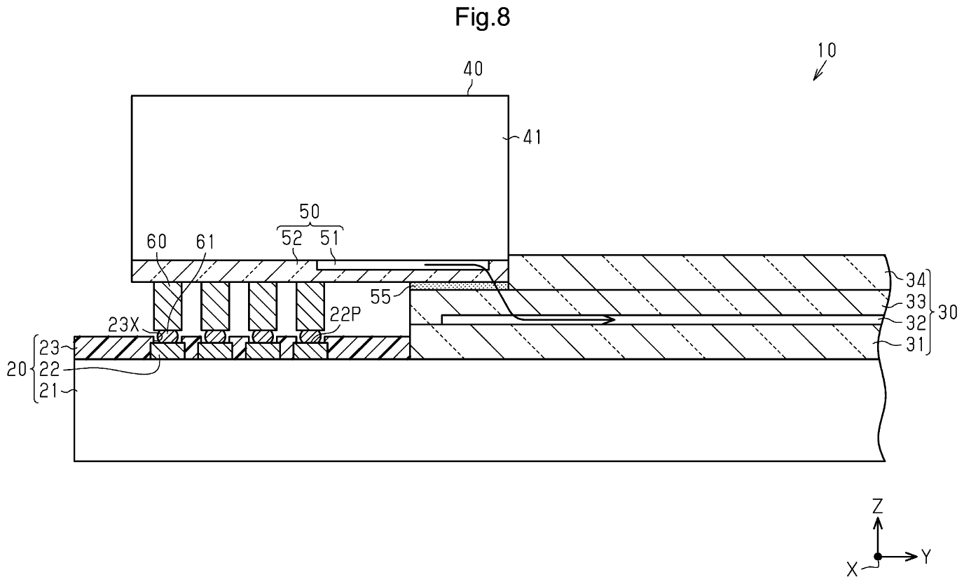

In an example, as illustrated in FIG. 8, a separator that separates the cores 32 from the core 51 in the Z-axis direction may have a three-layer structure including the cladding layer 33, an adhesive 55, and the cladding layer 52. In this optical module 10, the cladding layer 52 of the optical component 40 is bonded to the cladding layer 33 of the optical waveguide 30 by the adhesive 55. The adhesive 55 is bonded to the upper surface of the cladding layer 33 exposed from the cladding layer 34, and is bonded to the lower surface of the cladding layer 52. In this optical module 10, the adhesive bonds, for example, the cured cladding layer 33 and the cured cladding layer 52. The adhesive 55 may be, for example, an optical adhesive. The optical adhesive may be, for example, an UV-curable optical adhesive.

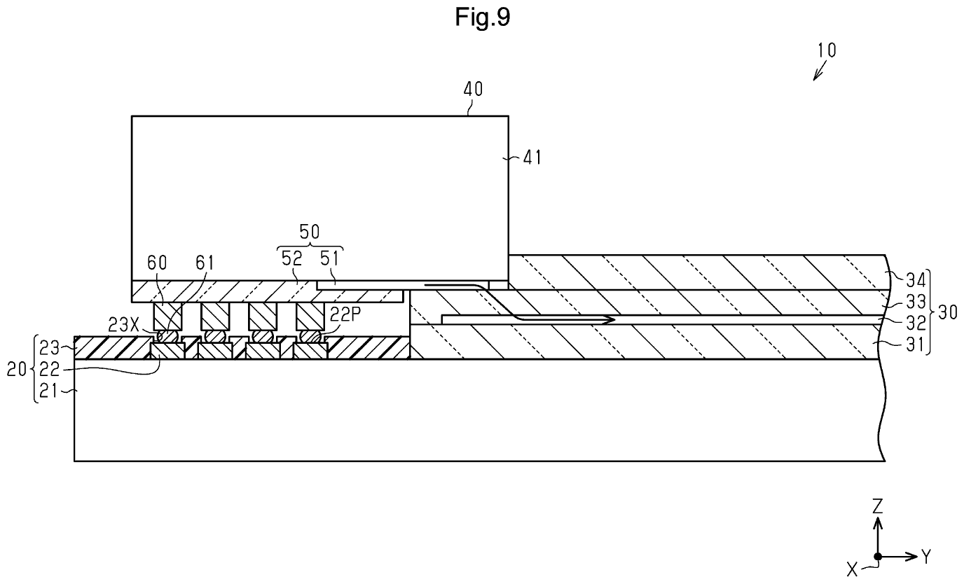

As illustrated in FIG. 9, the separator that separates the cores 32 from the core 51 in the Z-axis direction may have a single-layer structure including only the cladding layer 33.

In this optical module 10, the core 51 exposed from the cladding layer 52 is directly bonded to the upper surface of the cladding layer 33 exposed from the cladding layer 34. In this optical module 10, the core 51 is arranged on the upper surface of the cladding layer 33 that is in an uncured state (rubber state), and then the cladding layer 33 is cured to bond the cladding layer 33 and the core 51.

The structure of the optical component 40 of the above embodiment may be changed.

The structure of the optical waveguide 50 in the optical component 40 of the above embodiment may be changed. For example, the optical waveguide 50 may have a structure in which a cladding layer is arranged on the lower surface of the main body 41, the core 51 is formed on the lower surface of the said cladding layer, and the cladding layer 52 covers the core 51.

In the above embodiment, the core 51 includes the tapered portion 51B. However, the core 51 does not have to include the tapered portion 51B.

The optical component 40 of the above embodiment includes a single optical waveguide 50. However, the number of optical waveguides 50 is not particularly limited. For example, there may be two or more optical waveguides 50.

In the above embodiment, the optical waveguide 50 is embodied in a silicon optical waveguide. Instead, the optical waveguide 50 may be, for example, a glass optical waveguide, a polymer optical waveguide, or the like.

In the above embodiment, the optical component 40 is flip-chip mounted on the wiring substrate 20. Instead, the optical component 40 may be mounted on the wiring substrate 20 by, for example, wire bonding, solder mounting, or the like.

In the optical module 10 of the above embodiment, the optical component 40, serving as the first optical component, is embodied in a PIC element. Instead, the optical component 40 may be, for example, an optical component other than a PIC element. For example, the optical component 40 may be a planar lightwave circuit (PLC).

The structure of the optical waveguide 30 of the above embodiment may be changed.

The cladding layer 34 of the above embodiment may be omitted.

In the above embodiment, the optical waveguide 30 includes three cores 32. However, the number of cores 32 is not particularly limited. For example, there may be two or four or more cores 32.

In the above embodiment, the core 32 includes the tapered portion 32E. However, the core 32 does not have to include the tapered portion 32E.

In the above embodiment, the optical waveguide 30 is formed on the upper surface of the substrate body 21 exposed from the solder resist layer 23. Instead, the optical waveguide 30 may be formed on, for example, the upper surface of the solder resist layer 23.

In the above embodiment, the optical waveguide 30 is embodied in a polymer optical waveguide. Instead, the optical waveguide 30 may be, for example, a silicon optical waveguide, a glass optical waveguide, or the like.

In the optical module 10 of the above embodiment, the second optical component is embodied in the optical waveguide 30. Instead, the second optical component may be, for example, an optical component other than the optical waveguide 30.

The optical module 10 of the above embodiment includes a single optical waveguide 30. However, the number of optical waveguides 30 is not particularly limited. For example, there may be two or more optical waveguides 30.

The optical module 10 of the above embodiment includes a single optical component 40. However, the number of optical components 40 is not particularly limited. For example, there may be two or more optical components 40.

In the optical module 10 of the above embodiment, the optical component 40 includes the optical waveguide 50 having the single core 51, and the optical waveguide 30 including the multiple cores 32 is arranged on the wiring substrate 20. Instead, for example, the optical component 40 may include the optical waveguide 30 having the multiple cores 32, and the optical waveguide 50 including the single core 51 may be arranged on the wiring substrate 20.

The structure of the wiring substrate 20 of the above embodiment may be changed. For example, the solder resist layer 23 may be omitted.

### Application Example of Optical Module 10

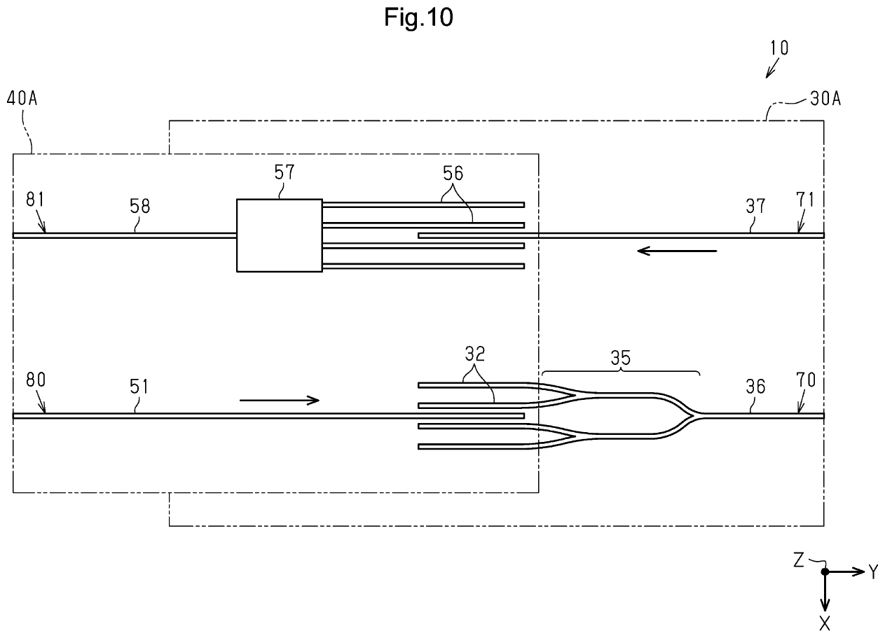

FIG. 10 illustrates an application example of the optical module 10 of the above embodiment. FIG. 10 is a plan view of the optical module 10 taken in the Z-axis direction. The optical module 10 is seen through the wiring substrate 20, the cladding layers 33 and 34, and the main body 41, and the like. The arrows in FIG. 10 indicate the directions of light propagation.

The optical module 10 of the present application example includes an optical waveguide 30A, and an optical component 40A arranged on the optical waveguide 30A.

### Structure of Optical Waveguide 30A

The optical waveguide 30A includes, for example, one or more (in this example, one) optical waveguide 70 and one or more (in this example, one) optical waveguide 71.

The optical waveguide 70 includes multiple (in this example, four) cores 32, an optical multiplexer 35, and a single core 36. The four cores 32 are arranged side by side in the X-axis direction. The four cores 32 extend in the Y-axis direction.

Examples of the optical multiplexer 35 may include a Y-shaped optical coupler, a multi-mode interference (MMI) coupler, a directional coupler, and the like. The optical multiplexer 35 of the present application has a structure of a tournament tree having two or more levels (here, two levels). The optical multiplexer 35 allows optical coupling between the four cores 32 and the single core 36. The optical multiplexer 35 optically couples the four cores 32 to the single core 36. The optical multiplexer 35 combines the light propagating through the four cores 32, and outputs the combined light to the single core 36. The single core 36 extends, for example, in the Y-axis direction.

The optical waveguide 71 includes a single core 37. The core 37 extends in the Y-axis direction.

### Structure of Optical Component 40A

The optical component 40A includes, for example, one or more (in this example, one) optical waveguides 80 that are optically connected to the optical waveguide 70, and one or more (in this example, one) optical waveguides 81 that are optically connected to the optical waveguide 71.

The optical waveguide 80 includes a single core 51. The core 51 extends in the Y-axis direction. The core 51 overlaps the four cores 32 in the lengthwise direction of the core 51 (Y-axis direction). The single core 51 is optically coupled to the four cores 32 by adiabatic coupling. The single core 51 and the four cores 32 are arranged to allow optical coupling from the single core 51 to the multiple cores 32.

The light input to the single core 51 is transferred to the four cores 32. Then, the light transferred to the four cores 32 is combined by the optical multiplexer 35, and is propagated to the single core 36. Accordingly, the optical waveguide 70 and the optical waveguide 80 form a pair of channels. The optical module 10 may include multiple pairs of channels each formed by the optical waveguide 70 and the optical waveguide 80.

The optical waveguide 81 includes multiple (in this example, four) cores 56, an optical multiplexer 57, and a single core 58. The four cores 56 are arranged side by side in the X-axis direction. The four cores 56 extend in the Y-axis direction.

Examples of the optical multiplexer 57 may include a Y-shaped optical coupler, an MMI coupler, a directional coupler, and the like. The optical multiplexer 57 allows optical coupling between the four cores 56 and the single core 58. The optical multiplexer 57 optically couples the four cores 56 to the single core 58. The optical multiplexer 57 combines the light propagating through the four cores 56, and outputs the combined light to the single core 58. The single core 58 extends, for example, in the Y-axis direction.

The four cores 56 overlap the single core 37 in the lengthwise direction of the core 56 (Y-axis direction). The single core 37 is optically coupled to the four cores 56 by adiabatic coupling. The single core 37 and the four cores 56 are arranged to allow optical coupling from the single core 37 to the multiple cores 56.

The light input to the single core 37 is transferred to the four cores 56. Then, the light transferred to the four cores 56 is combined by the optical multiplexer 57, and is propagated to the single core 58. Accordingly, the optical waveguide 71 and the optical waveguide 81 form a pair of channels. The optical module 10 may include multiple pairs of channels each formed by the optical waveguide 71 and the optical waveguide 81.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An optical module, comprising:
a first optical component including a single first core;
a second optical component including multiple second cores optically coupled to the single first core by adiabatic coupling; and
a separator separating the single first core from the multiple second cores in a first direction, wherein
the first optical component is a separate component from the second optical component,
the single first core and the multiple single second cores are arranged to allow optical coupling from the single first core to the multiple second cores,
the multiple second cores are arranged side by side in a second direction that is orthogonal to the first direction,
the single first core overlaps the multiple second cores in an overlapping region in a third direction that is orthogonal to both the first direction and the second direction, and
a first separation distance between two adjacent ones of the multiple second cores in the second direction is greater than or equal to a second separation distance between the single first core and the multiple second cores in the first direction.

2. The optical module according to claim 1, wherein
the first optical component includes a first cladding layer covering the single first core,
the second optical component includes a second cladding layer covering the multiple second cores,
the first optical component is arranged on the second optical component so that the first cladding layer is bonded onto the second cladding layer, and
the separator has a two-layer structure including the first cladding layer and the second cladding layer.

3. The optical module according to claim 1, wherein
the first optical component includes a first cladding layer covering the single first core,
the second optical component includes a second cladding layer covering the multiple second cores,
the first optical component is arranged on the second optical component so that the first cladding layer is bonded onto the second cladding layer via an adhesive, and
the separator has a three-layer structure including the first cladding layer, the adhesive, and the second cladding layer.

4. The optical module according to claim 1, wherein
the second optical component includes a second cladding layer covering the multiple second cores,
the first optical component is arranged on the second optical component so that the single first core is bonded onto the second cladding layer, and
the separator has a single-layer structure including only the second cladding layer.

5. The optical module according to claim 1, wherein
the single first core includes a first end in a lengthwise direction of the single first core and a first tapered portion having a cross-sectional area that decreases toward the first end, and
the first end and the first tapered portion are arranged in the overlapping region.

6. The optical module according to claim 1, wherein
the multiple second cores each include a second end in a lengthwise direction of the multiple second cores and a second tapered portion having a cross-sectional area that decreases toward the second end, and
the second end and the second tapered portion are arranged in the overlapping region.

7. The optical module according to claim 1, wherein the single first core has a propagation constant that is greater than that of each of the multiple second cores.

8. The optical module according to claim 1, wherein the second optical component includes a single third core and an optical multiplexer optically coupling the multiple second cores to the single third core.

9. The optical module according to claim 1, further comprising:
a wiring substrate, wherein
the second optical component includes an optical waveguide formed on the wiring substrate, and
the first optical component is mounted on the wiring substrate and is arranged on the second optical component.

10. The optical module according to claim 9, wherein
the wiring substrate includes a connection pad, and
the first optical component is flip-chip mounted on the connection pad.

11. The optical module according to claim 1, wherein
the multiple second cores includes three or more second cores, and
the single first core partially overlaps each of the three or more second cores by an equal distance in the third direction in the overlap region.
